(19) United States
(12) Patent Application Publication
(10) Pub. No.: US 2012/0159400 A1
(43) Pub. Date: Jun. 21, 2012

(54) SYSTEM FOR LEARNED MOUSE MOVEMENT AFFINITIES

(75) Inventors: Al Chakra, Apex, NC (US); Liam Harpur, Dublin (IE); Mark Kelly, Dublin (IE); John Rice, Waterford (IE)

(73) Assignee: INTERNATIONAL BUSINESS MACHINES CORPORATION, Armonk, NY (US)

(21) Appl. No.: 12/973,697

(22) Filed: Dec. 20, 2010

(51) Int. Cl. G06F 3/048

(52) U.S. Cl. 715/856

(57) ABSTRACT

A system for learned mouse affinities, including: a context listener to determine a context in which a user is operating, wherein the context listener also listens for an occurrence of a trigger event within the context; a mouse listener to recognize a mouse action by the user; and a mapping stored on a memory device, wherein the mapping includes mouse actions mapped to context actions, wherein the context actions correspond to the trigger event, wherein the context action is implemented in response to the mouse action according to the profile and after the occurrence of the trigger event.

### BACKGROUND

Electronic mice allow users to interact with graphical user interfaces on a computing device in a number of ways, including moving a pointer within the interface, selecting objects, scrolling through applications, etc. The actions that users are able to perform using mice are becoming more versatile, but along with that versatility the mice frequently become more complex. Some mice include numerous buttons or other physical features that users interact with to perform a wide variety of functions. Even though such mice include many physical features for performing the various tasks, the mice as conventionally configured are typically limited in what they are able to do.

Some conventional methods of improving mouse capabilities include using mouse gestures to perform certain tasks within an environment. However, with conventionally configured mice even these gestures are limited in what they are able to do in certain situations or for performing certain tasks. Improving the capabilities of mouse actions (whether gestures or otherwise) within various contexts and environments may allow users to better optimize their interactivity.

### SUMMARY

Embodiments of a system are described. In one embodiment, the system is a system for learned mouse affinities, including: a context listener to determine a context in which a user is operating, wherein the context listener also listens for an occurrence of a trigger event within the context; a mouse listener to recognize a mouse action by the user; and a mapping stored on a memory device, wherein the mapping includes mouse actions mapped to context actions, wherein the context actions correspond to the trigger event, wherein the context action is implemented in response to the mouse action according to the profile and after the occurrence of the trigger event. Other embodiments of the system are also described. Embodiments of a computer program product and a method are also described. Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a system for learned mouse affinities.

FIG. 2 depicts a schematic diagram of one embodiment of the graphical user interface of FIG. 1.

FIG. 3 depicts a schematic diagram of one embodiment of a system for learned mouse affinities.

FIG. 4 depicts schematic diagram of one embodiment of a mapping profile.

FIG. 5 depicts a flow chart diagram of one embodiment of a method for learning mouse movement affinities.

FIG. 6 depicts a flow chart diagram of one embodiment of a method for implementing mouse movement affinities.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments present a system and method for learning and implementing mouse movement affinities. More specifically, the system maps mouse actions to context actions within a determined context and after the occurrence of a trigger event, and allows a user to perform the context action by simply executing the corresponding mouse action.

As used herein and in the appended claims, the term “mouse action” refers broadly to any mouse movement, series of mouse movements, mouse clicking, or any other mouse interaction by a user. Examples of mouse movements include, but are not limited to, side-to-side movements, diagonal movements, forward or backward movements, up-and-down movements (lifting the mouse), or any combination of these or other movements.

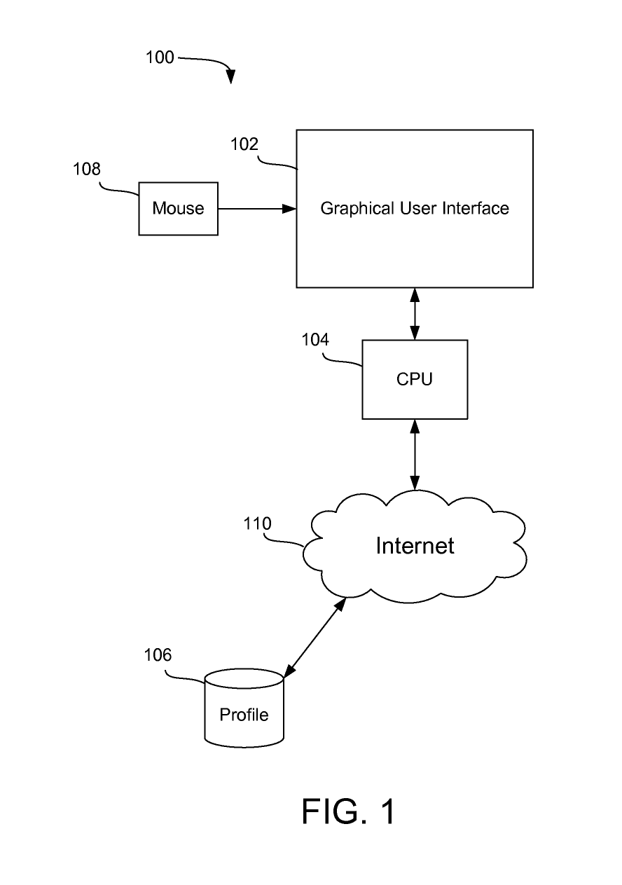

FIG. 1 depicts a schematic diagram of one embodiment of a system 100 for learned mouse affinities. The illustrated system 100 for learned mouse affinities includes a graphical user interface (GUI) 102, a processing device 104, and a profile storage device 106. Although the system 100 is shown and described with certain components and functionality, other embodiments of the system 100 may include fewer or more components to implement less or more functionality.

The system 100 allows a user to interact with a GUI 102 using a mouse 108 in order to accomplish various tasks. The system 100 includes a processing device 104, such as a computer processing unit (CPU), for executing commands and processing actions through the GUI 102. The system 100 determines a context within the GUI 104 in which the user is operating. While operating in the determined context, a trigger event may occur that allows a certain action or actions by the user. The allowed actions are context actions that may be unique to the specific trigger event. In some embodiments, the user uses the mouse 108 to select one of the context actions, such as using the mouse 108 to click on a button to perform the context action. In other embodiments, the user uses keyboard keys or other user input to select a context action to perform.

The number and type of trigger events that occur and context actions that the user may perform depend on the context. Some contexts may include numerous trigger events that allow or require a user to perform many different actions. In such embodiments, performing the context actions can take time and attention. By improving the way in which the user may perform the action, the performance efficiency may increase.

As described herein, the system 100 provides a method for learning and implementing mouse movement affinities. The system 100 allows the user to map mouse actions to specific context actions, such that when the user performs a mouse action within the given context and after a trigger event the system will perform the context action mapped to the mouse action. In some embodiments, the mouse actions are automatically mapped to the context actions using a learning mechanism. In other embodiments, the user manually maps the mouse actions to the context actions.

In one embodiment, the CPU 104 accesses a profile on a remote profile storage device 106 through an Internet 110 connection. The profile stores personalized mappings of mouse actions to context actions for the user. The profile storage device 106 may allow the profile to be accessible to any number of devices, which may allow the user to access and use the personalized mappings irrespective of the device. In another embodiment, the profile is stored locally.

The mouse actions are performed by the user within the GUI 102. In one embodiment, the mouse actions include non-standard movements that are unique from normal mouse movements that a user might perform while operating within the GUI 102. Implementing unique mouse actions may help prevent the user from accidentally performing a context action while attempting to perform another context action, or while performing another action not related to the trigger event.

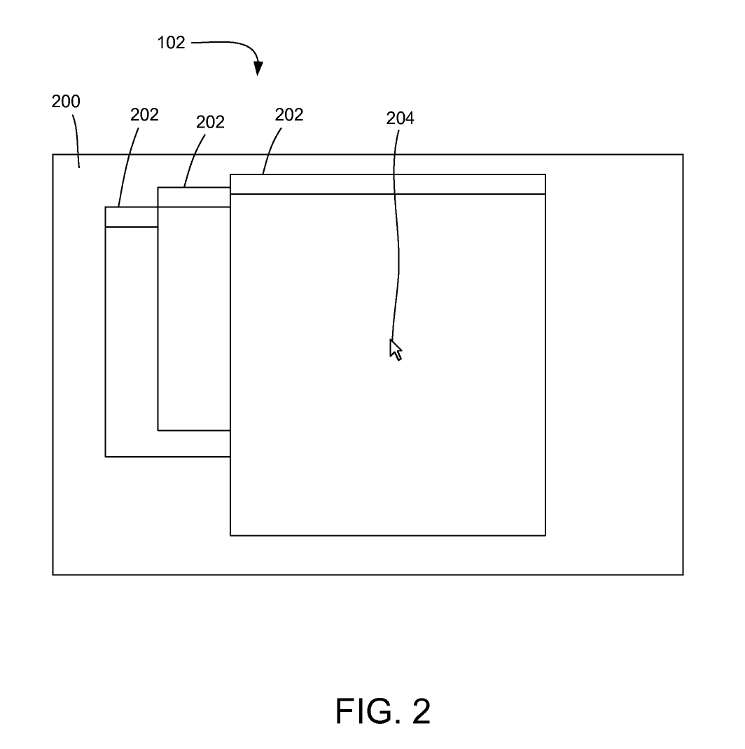

FIG. 2 depicts a schematic diagram of one embodiment of the GUI of FIG. 1. The GUI may operate in a number of computing environments. In one embodiment, the GUI includes a desktop for an operating system. Desktops provide users with an environment in which to perform many tasks in many different applications. Advances in technology have increased the ability for users to multitask within the desktop environment, such that users may have several windows open at a time on the desktop.

Each of the windows open within the desktop may be a context within which the user may operate that has mappings between mouse actions and context actions. In one embodiment, the desktop is a context that may have mappings associated with certain trigger events on the desktop. The system may determine in which context the user is operating by determining which window or context is in focus. In one embodiment, a trigger event causes the context to which it is related to be placed in focus. In some embodiments, the context that is currently in focus does not have to be displayed on top of all the other contexts. In one embodiment, the context in focus may be determined by a position of the mouse pointer on the GUI.

The GUI in the present embodiment has three windows open on a desktop, such that the GUI has four contexts, including the desktop. In one example, the top window is the context presently in focus. When the context in focus has a trigger event occur, the user may then use a mouse action to perform one of the context actions related to the trigger event. In one embodiment, each trigger event in each context has different mappings for mouse actions to context actions. In another embodiment, the mappings for more than one trigger event or for more than one context are the same.

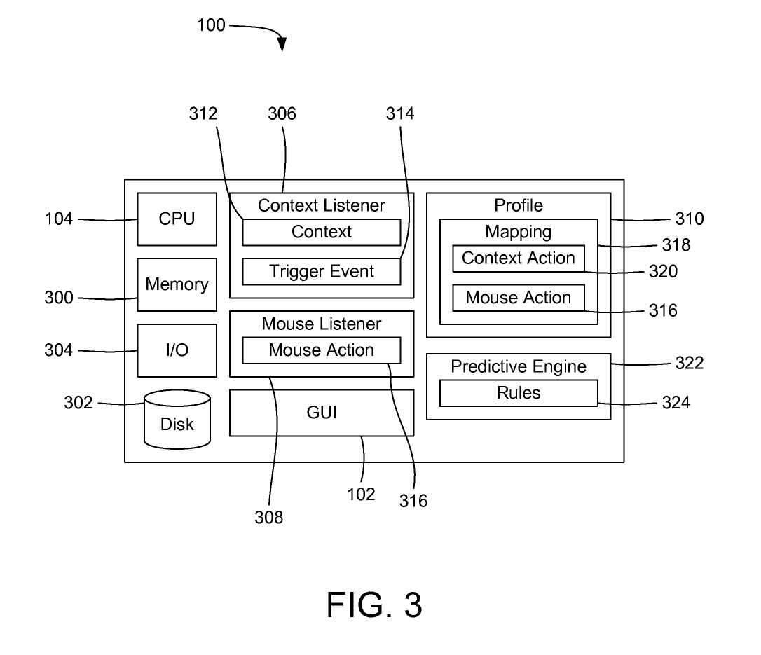

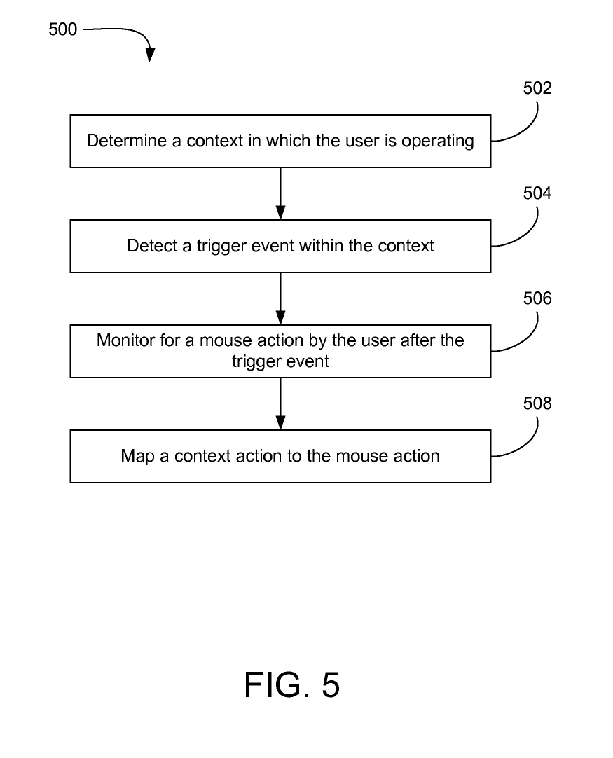

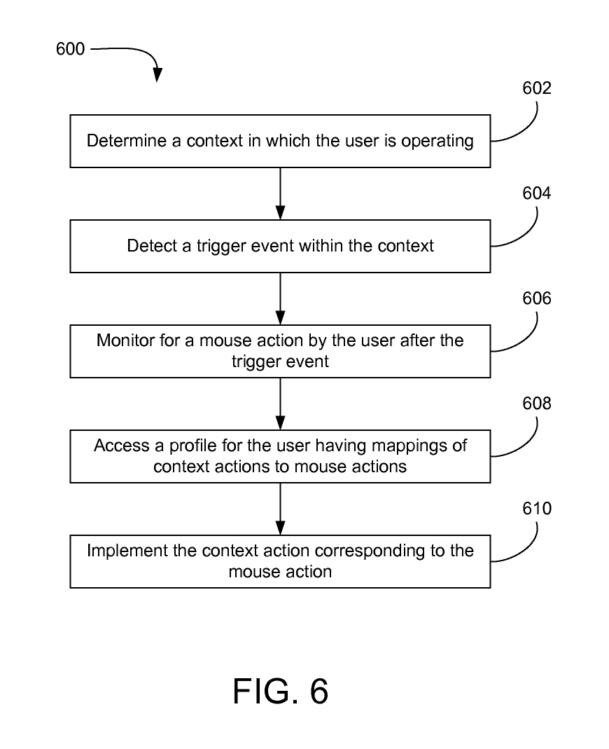

FIG. 3 depicts a schematic diagram of one embodiment of a system for learned mouse affinities. The depicted system for learned mouse affinities includes various components, described in more detail below, that are capable of performing the functions and operations described herein. In one embodiment, at least some of the components of the system for learned mouse affinities are implemented in a computer system. For example, the functionality of one or more components of the system may be implemented by computer program instructions stored on a computer memory device and executed by a processing device such as a CPU. The system may include other components, such as a disk storage drive, input/output devices, a context listener, a mouse listener, and a user profile. Some or all of the components of the system may be stored on a single computer or on a network of computers. The system may include more or fewer components than those depicted herein. In some embodiments, the system may be used to implement the methods described herein as depicted in FIGS. 5 and 6.

The context listener monitors the GUI to determine which context is currently in focus. The context in focus is the context in which the user is currently operating or interacting with the GUI. In one embodiment, the context is an application such as a word processor. The context may be any application or operating environment, including operating systems, web browsers, or other programs that allow a user to interact with the GUI.

The context listener also monitors for a trigger event within a particular context. In some embodiments, the trigger event may draw the focus from another context to the context for which the trigger event occurs. The mouse listener listens for mouse actions performed by the user within the context. Mouse actions may include mouse movements within the GUI, clicking the mouse buttons, lifting the mouse off of a surface, using a mouse scroll wheel, or other interactions that a user may have with the mouse to perform actions within the GUI.

After a trigger event occurs, the system may access a profile corresponding to the user. The profile, after being set up, includes mappings of context actions to mouse actions. In one embodiment, the profile learns the mappings from user interaction with the GUI. In other embodiments, the user is able to set up the profile manually to include mappings of context actions to mouse actions. The mapped context actions are actions that may be performed for the trigger events corresponding to each context. The mouse actions that the system maps to the context actions may include unique actions that are identifiable by the system and the user.

In one example, the user is operating in a word processor to create or modify a text document. If the user selects a portion of text, selecting the text may be a trigger event configured to allow the user to perform one or more context actions. Context actions in this example may include bolding or italicizing the selected text, or copying the selected text. In another example, the user is operating in an application and a notification window for the application appears. The application is the context and the notification window is the trigger event. When the notification window appears, the user may be presented with several options in the notification window. Some options may include selecting one of several buttons, for example, or some other option that the notification window presents. The available options are the context options.

When the user is presented with a context option, the user may implement a context action that is mapped to a mouse action by performing the mouse action. The system may include a predictive engine to create the mappings between the context actions and mouse actions. The predictive engine may create the mappings based on predetermined rules. In one embodiment, the rules include a time threshold, such that the system only maps the mouse action to a context action if the context action is performed within the time threshold. The user may train the predictive engine to create the mapping for a given mouse action and context action by performing the mouse action with the context action one or more times. The predictive engine may store the mouse action performed in the mapping with the context action. In some embodiments, if the user performs does not perform the mouse action exactly the same (such as a series of movements in a certain direction that may have slight differences each time, but are substantially similar), the predictive engine may store a single mouse action in the mapping that is substantially similar to the series of mouse actions.

Once at least one mapping is created, the predictive engine may be configured to monitor for a mouse action or series of mouse actions that correspond to a mapping stored in the profile. When the user performs the mouse action, the predictive engine accesses the profile and looks for the mapping for the corresponding context action, and the system then performs the context action.

The profile may be stored locally on the storage disk or remotely on another computing device. In one embodiment, the profile is stored remotely, such that when the system attempts to access the profile, the system must download the profile over an Internet connection. Once the profile is downloaded, the system may use the profile to perform the context actions mapped to mouse actions on the local computing device. The user may alter the profile and upload the profile to the remote computing device from which the profile was downloaded. This may allow the user to access the profile from any computing device through a remote connection and alter the profile according to his preferences.

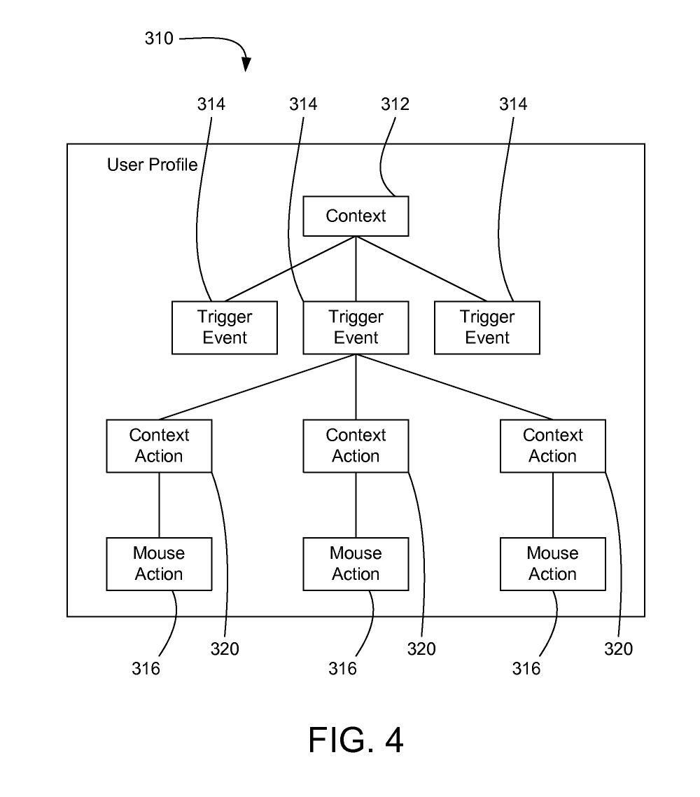

FIG. 4 depicts schematic diagram of one embodiment of a mapping profile. In one embodiment, the profile is configured to contain all mappings for each possible context that allows the performance of context actions through mouse actions. In another embodiment, the profile is configured to contain all mappings for a single context, such that the profile is specific to the context. The system may use one or more profiles for a single user. The system may also include one or more profiles for each user authorized to use a single computing device or system.

The profile may include a tree structure, such as that shown in the present embodiment. A first level of the tree structure displays a mapping context. A second level includes all of the possible trigger events for the context. The context may include many trigger events. Under each trigger event at a third level, the profile tree structure includes a one-to-one mapping of context actions and mouse actions, such that a single mouse action is mapped to a single context action, and vice versa.

Because the profile may include all mappings for every context action/mouse action for each trigger event in each context, the profile may include many different combinations of mappings. The user may use the same mouse actions across all trigger events and/or contexts, or the user may use different mouse actions. In one embodiment, some or all of the context actions for one trigger event may overlap with the context actions of another trigger event in the same or different context. Consequently, the profile may share portions of the profile mapping structure with other portions of the profile mapping structure. Other embodiments of the profile may include structures other than depicted herein for mapping the context actions to the mouse actions.

FIG. 5 depicts a flow chart diagram of one embodiment of a method for learning mouse movement affinities. Although the method is described in conjunction with the system for learned mouse movement affinities of FIG. 1, embodiments of the method may be implemented with other types of systems for learned mouse movement affinities.

The system determines a context in which the user is operating. The context may include an operating system GUI, such as a desktop, applications in the operating system, and any other context in which a user may operate in a computing environment. While several applications or other possible contexts may be running or open at any given time in a GUI, only one of the potential contexts may be in focus. The system listens for any trigger events. In one embodiment, the trigger event may be associated with the context in which the user is operating. In another embodiment, the trigger event corresponds to another context that is not currently in focus. In such an embodiment, the system may then place that context in focus. The trigger event may be any number of events that either require or allow the user to perform various actions, known as context actions.

After detecting the trigger event, the system monitors for a mouse action by the user after the trigger event. The mouse action may include one or more interactions between the user and the mouse, such as movements, clicking, scrolling, or other actions. In one embodiment, the user performs the mouse action before performing a context action allowed by the trigger event. In another embodiment, the user performs the mouse action after performing the context action. The system may be trained to relate the mouse action to the context action, such that the system maps the context action to the mouse action in the profile. In one embodiment, the context actions include a set of actions most frequently performed by the user within the specific context and for the corresponding trigger event. The system may offer default mappings of mouse actions to context actions for the context and trigger event.

In one example, the user is using an email client and clicks on a “send message” button. A window pops up asking the user if he wants to save the outgoing email. The window is a trigger event and presents the user with several options, for example, “yes,” “no,” and “cancel.” The user performs a mouse action, such as swiping left twice with the mouse, and then presses “c” on the keyboard for “cancel.” In one embodiment, the system is able to be trained after a single time performing the mouse action and context action. In another embodiment, the user performs the mouse action and context action several times for different emails to train the system. When the system determines that it has successfully learned the relation between the context action and the mouse action, the system may prompt the user to save the mouse action to the context action, and then to save the mapping to the profile if the user selects to save the mapping. In one embodiment, the system may request that the user input mouse actions for each of the context actions when the window pops up so that the system may have mappings for all of the context actions.

FIG. 6 depicts a flow chart diagram of one embodiment of a method for implementing mouse movement affinities. Although the method is described in conjunction with the system for learned mouse movement affinities of FIG. 1, embodiments of the method may be implemented with other types of systems for learned mouse movement affinities.

The system determines a context in which the user is operating. The context may include an operating system GUI, such as a desktop, applications in the operating system, and any other context in which a user may operate in a computing environment. While several applications or other possible contexts may be running or open at any given time in a GUI, only one of the potential contexts may be in focus. The system listens for any trigger events. In one embodiment, the trigger event may be associated with the context in which the user is operating. In another embodiment, the trigger event corresponds to another context that is not currently in focus. In such an embodiment, the system may then place that context in focus. The trigger event may be any number of events that either require or allow the user to perform various actions, known as context actions.

After detecting the trigger event, the system monitors for a mouse action by the user after the trigger event. The mouse action may include one or more interactions between the user and the mouse, such as movements, clicking, scrolling, or other actions. The system accesses a profile for the user having mappings of context actions to mouse actions. In the present method embodiment, the system has learned at least one mouse action and mapped the mouse action to a context action for the trigger event in the present context. By accessing the profile, the system may be able to determine the types of mouse actions that the user has trained the system to recognize, as well as determining the context actions that are triggered by each specific mouse action.

After accessing the profile and determining that the mouse action performed by the user matches a mapping in the profile, the system implements the context action to which the mouse action is mapped. In one embodiment, the profile is stored on a local storage device. In other embodiment, the profile may be stored on a remote storage device and accessible to multiple devices such that the user is able to implement the context actions and mouse actions on other devices.

As an example of the present method, the system has mapped a mouse action of swiping left twice to a context action of pressing “c” on the keyboard to cancel the trigger event. When the user performs the mapped mouse action by swiping left twice with the mouse, the system automatically performs the context action in response to the trigger event, such that swiping left twice cancels the trigger event. In one embodiment, after performing the context action, the system allows the user to modify the mapping of the context action to the mouse action.

An embodiment of a system for learned mouse movement affinities includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to learn and integrate mouse movement affinities in a computing environment. The operations are able to learn the mouse movement affinities of a user and map those movements to actions performed within a given context and after certain trigger events have occurred within the context. The operations are also able to implement the stored mappings to perform the context actions when the user performs the stored mouse actions.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product, comprising:
a computer readable storage medium to store a computer readable program, wherein the computer readable program, when executed by a processor within a computer, causes the computer to perform operations for learning mouse movement affinities, the operations comprising:
determining a context in which a user is operating;
detecting a trigger event within the context;
monitoring for a mouse action by the user after the trigger event; and
storing a mapping on a memory device, wherein the mapping comprises a context action mapped to the mouse action, wherein the context action corresponds to the trigger event.

2. The computer program product of claim 1, wherein monitoring for the mouse action comprises monitoring for a series of mouse actions by the user and a context action after the trigger event, wherein the context action is mapped to a mouse action substantially similar to the series of mouse actions.

3. The computer program product of claim 1, wherein the computer program product, when executed on the computer, causes the computer to perform additional operations, comprising:
determining whether the context action occurs within a time threshold of the mouse action.

4. The computer program product of claim 1, wherein the computer program product, when executed on the computer, causes the computer to perform additional operations, comprising:
mapping a plurality of context actions to different mouse actions, wherein the context actions comprise a set of context actions frequently performed by the user within the context and for the trigger event.

5. The computer program product of claim 1, wherein the computer program product, when executed on the computer, causes the computer to perform additional operations, comprising:
storing the mapped context action and mouse action in a profile for the user, wherein the profile is accessible to a plurality of devices to grant access to the user to perform the context action using the mouse action on each of the devices.

6. The computer program product of claim 1, wherein the mouse action comprises a series of movements.

7. The computer program product of claim 1, wherein the computer program product, when executed on the computer, causes the computer to perform additional operations, comprising:
receiving an input from the user to manually overwrite mapped context actions or mouse actions.

8. A system, comprising:
a context listener to determine a context in which a user is operating, wherein the context listener also listens for an occurrence of a trigger event within the context;
a mouse listener to recognize a mouse action by the user; and
a mapping stored on a memory device, wherein the mapping comprises mouse actions mapped to context actions, wherein the context actions correspond to the trigger event,
wherein the context action is implemented in response to the mouse action according to the profile and after the occurrence of the trigger event.

9. The system of claim 8, further comprising a predictive engine to automatically create the mapping of mouse actions to context actions, wherein the predictive engine creates the mapping based on defined rules for correlations between the mouse actions and the context actions.

10. The system of claim 9, wherein the rules comprise a time threshold between the mouse actions and the context actions.

11. The system of claim 9, wherein the predictive engine monitors for a series of mouse actions and a context action after the trigger event, wherein the predictive engine then maps the context action to a mouse action that is substantially similar to the series of mouse actions.

12. The system of claim 8, wherein the mapping is stored in a profile, wherein the profile is accessible to a plurality of devices to grant access to the user to perform the context action using the mouse action on each of the devices.

13. The system of claim 8, wherein the mouse action comprises a series of movements.

14. A method for learning mouse movement affinities, the method comprising:
determining a context in which a user is operating;
detecting a trigger event within the context;
monitoring for a mouse action by the user after the trigger event; and
storing a mapping on a memory device, wherein the mapping comprises a context action mapped to the mouse action, wherein the context action corresponds to the trigger event.

15. The method of claim 14, wherein monitoring for the mouse action comprises monitoring for a series of mouse actions by the user and a context action after the trigger event, wherein the context action is mapped to a mouse action substantially similar to the series of mouse actions.

16. The method of claim 14, further comprising:
determining whether the context action occurs within a time threshold of the mouse action.

17. The method of claim 14, further comprising:
mapping a plurality of context actions to different mouse actions, wherein the context actions comprise a set of context actions frequently performed by the user within the context and for the trigger event.

18. The method of claim 14, further comprising:
storing the mapped context action and mouse action in a profile for the user, wherein the profile is accessible to a plurality of devices to grant access to the user to perform the context action using the mouse action on each of the devices.

19. The method of claim 14, wherein the mouse action comprises a series of movements.

20. The method of claim 14, further comprising implementing the mouse movement affinities by:
monitoring for a further mouse action by the user after the trigger event;
accessing a mapping stored on the memory device, wherein the mapping comprises the further mouse action mapped to a context action, wherein the context action corresponds to the trigger event; and
implementing the context action in response to the further mouse action.
